(19) United States
(12) Patent Application Publication
(10) Pub. No.: US 2008/0149359 A1
(43) Pub. Date: Jun. 26, 2008

(54) Hand-Held Power Tool, in Particular Rotary Hammer and/or Chisel Hammer

(76) Inventor: Gerhard Meixner, Filderstadt (DE)

Correspondence Address: MICHAEL J. STRIKER, 103 EAST NECK ROAD, HUNTINGTON, NY, 11743, US

(21) Appl. No.: 11/914,789

(22) PCT Filed: Dec. 11, 2006
(86) PCT No.: PCT/EP2006/069522

§ 371 Date: Nov. 19, 2007

(30) Foreign Application Priority Data
Feb. 9, 2006 (DE) 102006005852.6

(51) Int. Cl. B23B 45/16

(52) U.S. Cl. 173/128

(57) ABSTRACT

The invention is based on a portable power tool, in particular a hammer drill and/or a rotary demolition hammer, comprising a motor (10a, 10b, 10c) and a motor shaft (12a, 12b, 12c), comprising a percussion mechanism unit (14a, 14b, 14c) which can be driven by the motor (10a, 10b, 10c) for achieving an impulse in the direction of a percussion axis (16a, 16b, 16c) and which has an axial drive unit (18a, 18b, 18c) having an output means (20a, 20b, 20c), and comprising a transmission unit (22a, 22b, 22c) which is provided for transmitting a drive force 15 from the axial drive unit (18a, 18b, 18c) to a piston unit (24a, 24b, 24c). It is proposed that, in the region of the transmission unit (22a, 22b, 22c), the motor shaft (12a, 12b, 12c), as viewed in the longitudinal direction 20 of the percussion axis (16a, 16b, 16c), be directed laterally past at least one part of the transmission unit (22a, 22b, 22c).

### RELATED ART

The present invention is directed to a hand-held power tool according to the definition of the species in claim 1.

Publication DE 102 59 566 A1 makes known a hand-held power tool designed as a chisel hammer that includes a motor, which is provided as an electric motor, and that includes a motor shaft and an impact mechanism, which is driveable by the motor, for generating an impulse in the direction of an impact axis. The impact mechanism includes an axial drive unit, which is provided as an eccentric unit, with a driven element formed by an eccentric peg. The hand-held power tool also includes a transmission unit, which is formed by a connecting rod and which is provided to transfer a drive force from the axial drive unit to a piston unit. The transmission unit and the motor shaft are separated, as viewed in the longitudinal direction of the impact axis.

### ADVANTAGES OF THE INVENTION

The present invention is directed to a hand-held power tool, in particular a rotary hammer and/or chisel hammer, including a motor and a motor shaft, an impact mechanism—which is driveable by the motor, generates an impulse in the direction of an impact axis, and includes an axial drive unit with a driven element—and including a transmission unit provided to transfer a drive force from the axial drive unit to a piston unit.

It is provided that the motor shaft—as viewed in the longitudinal direction of the impact axis, in the region of the transmission unit—is guided laterally past at least a portion of the transmission unit. An “axial drive unit” refers, in particular, to a unit that is provided to convert a rotary motion into an axial motion, such as a cam mechanism and/or, particularly advantageously, an eccentric unit, which may be realized with a simple, space-saving, and robust design. A “driven element” refers to an element that brings about at least a portion of a conversion of rotational motion to axial motion via, in particular, its shape and/or, in particular, its location. Examples include an eccentric peg or a cam with a matching eccentric recess, etc., and which forms an interface with a transmission unit provided for transmitting a drive force from the axial drive unit to a piston unit, e.g., in particular, a connecting rod unit and/or a push unit that are/is guided on a curved path of the axial drive unit.

Via an inventive design of this type, installation space and weight may be reduced, and a particularly compact design may be attained. Moreover, a hand-held power tool may be advantageously attained, the center of mass of which is close to the impact axis.

When the transmission unit includes a recess through which the motor shaft is guided, so that the motor shaft is guided past two—in particular—parts of the transmission unit that are diametrically opposed to the impact axis, a transfer of force may be attained using the transmission unit, which is advantageous and, in particular, at least largely symmetrical. It would also be feasible, in principle, for the motor shaft to be guided past the transmission unit on only one side.

Furthermore, installation space may be reduced when the eccentric unit—as viewed in the longitudinal direction of the motor shaft—is supported at least on a side facing away from the motor and, in particular, at least partially on a side of a driven region of the motor shaft facing away from the motor, and/or when the eccentric unit is supported on one side, in particular relative to a driven element of the eccentric unit, such as an eccentric peg, an eccentric cam, etc. A “driven region” of the motor shaft refers, in particular, to a coupling point with a motor pinion or a motor pinion itself.

When the hand-held power tool includes an intermediate wheel for rotationally driving a tool fitting, which—as viewed in the longitudinal direction of the motor shaft—is located at least partially on a side of the impact axis facing away from the motor and preferably on a side of a driven region of the motor shaft facing away from the motor, the rotary drive of the tool fitting may be realized in a space-saving manner, in particular when the intermediate wheel—as viewed in the longitudinal direction of the impact axis—is located at least partially on the side of the motor shaft facing the tool fitting, thereby preferably enabling a motor pinion—which is driveably directly by the motor shaft—to be coupled—directly, advantageously—with the intermediate wheel, thereby enabling it to be used simultaneously, in particular, to directly drive at least two gearwheels. “Directly” refers, in particular, to a configuration without the intermediate engagement of further intermediate wheels, but configurations are to be included, in particular, which include components that are intermediately engaged and fixedly coupled with the motor pinion and/or the motor shaft, at least during operation.

Furthermore, an advantageously space-saving rotary drive may be realized with a desired ratio with a simple design in particular when the hand-held power tool includes an intermediate wheel for rotationally driving a tool fitting, the intermediate wheel being coupled directly with a driven element of the axial drive unit.

### DRAWING

Further advantages result from the description of the drawing, below. Exemplary embodiments of the present invention are shown in the drawing. The drawing, the description and the claims contain numerous features in combination. One skilled in the art will also advantageously consider the features individually and combine them to form further reasonable combinations.

FIG. 1 shows a schematicized longitudinal sectional view of a hand-held power tool designed as a chisel hammer,

FIG. 1a shows a section of a schematicized sectional view along line Ia-Ia in FIG. 1,

FIG. 2 shows a schematicized longitudinal sectional view of a hand-held power tool designed as a rotary hammer, and

FIG. 3 shows a schematicized longitudinal sectional view of an alternative hand-held power tool designed as a rotary hammer.

### DESCRIPTION OF THE EXEMPLARY EMBODIMENTS

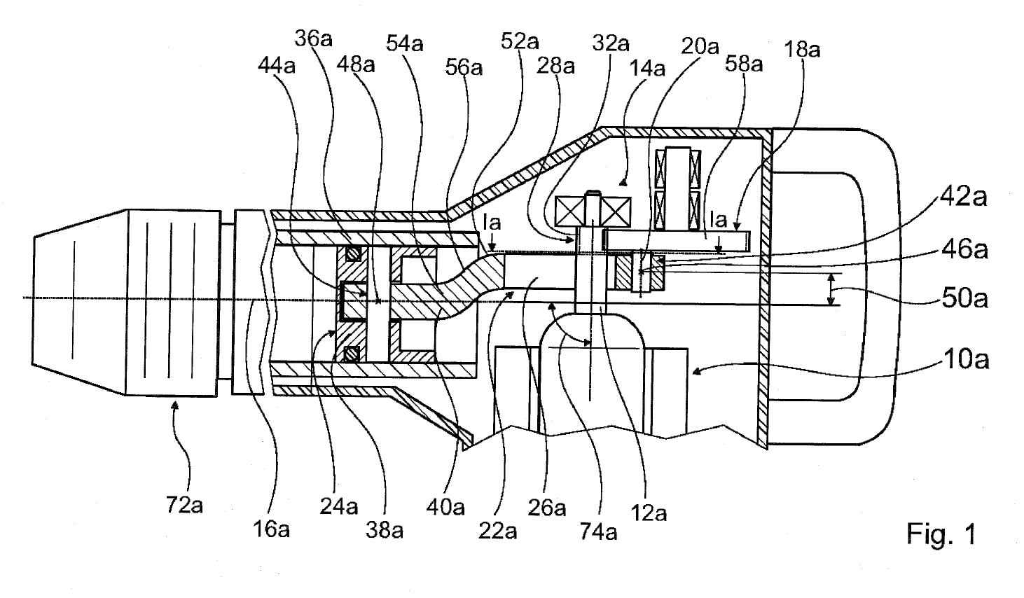

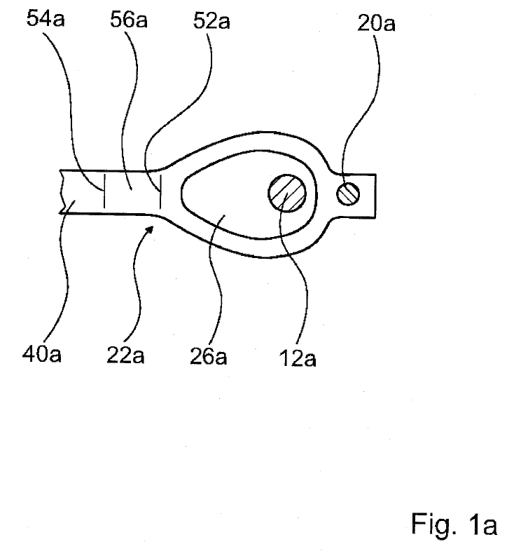

FIG. 1 shows a schematicized longitudinal section view of a hand-held power tool designed as a chisel hammer that includes a motor 10a, which is provided as an electric motor, and that includes a motor shaft 12a and an impact mechanism 14a, which is driveable by motor 10a via motor shaft 12a, for generating an impulse in the direction of an impact axis 16a. Impact mechanism 14a includes an axial drive unit 18a designed as an eccentric unit, with a driven element 20a designed as an eccentric peg. Axial drive unit 18a includes a gearwheel 58a that meshes with a motor pinion 32a integrally formed with motor shaft 12a, and on which driven element 20a is directly located, on a side facing motor 10a. Driven element 20a, as viewed in the longitudinal direction of motor shaft 12a, is located essentially on the side of motor pinion 32a or the side of a driven region 28a of motor shaft 12a formed by motor pinion 32a that faces motor 10a.

Impact mechanism 14a also includes a transmission unit 22a, which is provided to transmit a drive force from driven element 20a of axial drive unit 18a to a piston unit 24a and/or to a piston 38a, which is guided in a hammer tube 36a. Transmission unit 22a is formed essentially by a transmission element 40a designed as a connecting rod, and includes vertically offset joints 42a, 44a formed by connecting rod ends. Joints 42a, 44a, i.e., their centers 46a, 48a, formed by the connecting rod ends are separated—in the longitudinal direction of motor shaft 12a—by a distance 50a that preferably corresponds to at least one-half of an extension of a joint 42a, 44a in the direction of motor shaft 12a. To attain a height difference, transmission element 40a includes two 45° redirections 52a, 54a and a subregion 56a, which extends transversely to impact axis 16a. It would also be feasible in principle, however, for transmission element 40a to be designed perpendicular to motor shaft 12a and/or—as viewed in the side view shown—coaxial with and/or parallel to the impact axis 16a.

The hand-held power tool has an L shape, in which motor shaft 12a forms an angle 74a of 90° with impact axis 16a. Other angles that are not zero and that appear reasonable to one skilled in the art are also feasible, such as angles between 30° and 150° in particular. An orientation of motor shaft 12a that is coaxial or parallel with impact axis 16a is considered to be an angle equal to zero.

Transmission element 40a of transmission unit 22a includes a recess 26a through which motor shaft 12a is guided and, therefore, is guided laterally along two diametrically opposed parts of transmission unit 22a, as viewed in the longitudinal direction of impact axis 16a (FIGS. 1 and 1a). Recess 26a is dimensioned in a manner such that contact between motor shaft 12a and transmission element 40a is always prevented.

As viewed in the longitudinal direction of motor shaft 12a, the eccentric unit is supported on one side on a side of gearwheel 58a facing away from motor 10a and on a side—which faces away from motor 10a—of driven region 28a of motor shaft 12a formed by motor pinion 32a, which is integrally formed with motor shaft 12a. Motor shaft 12a is also supported on the side of driven region 28a facing away from motor 10a.

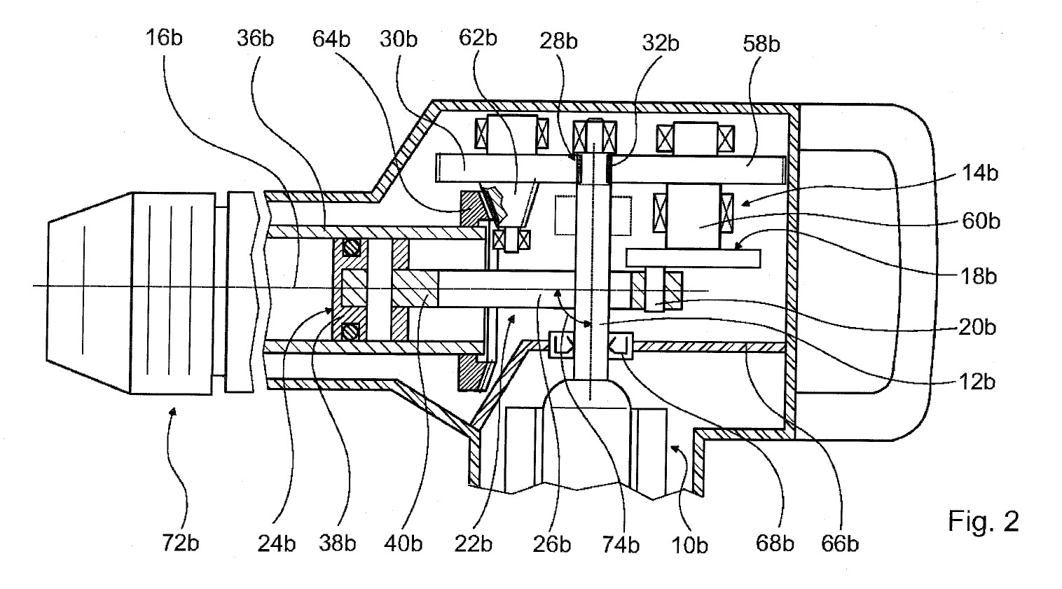

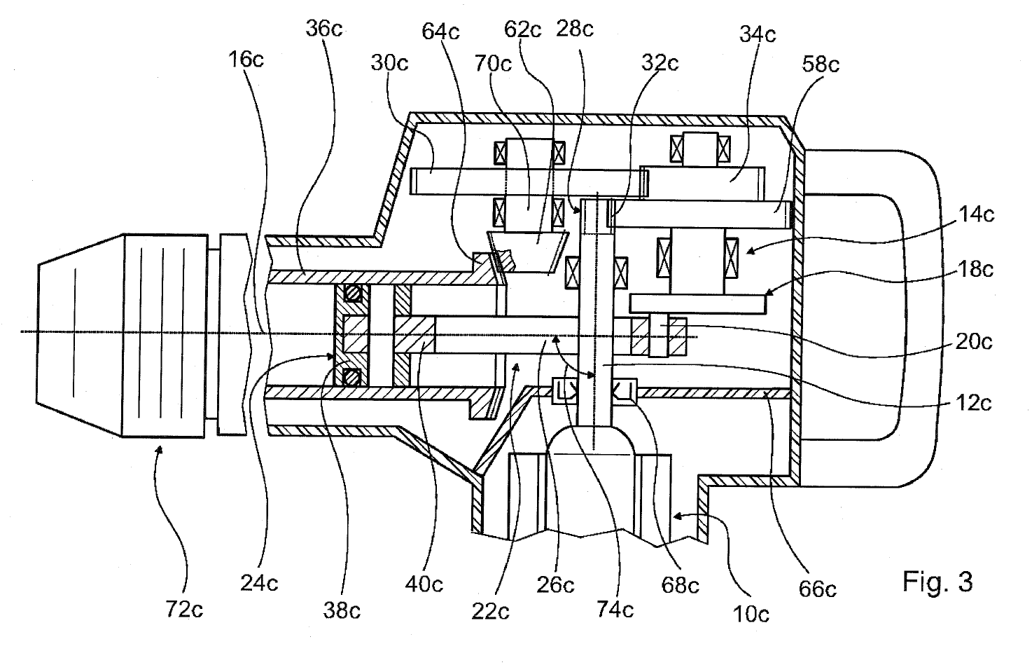

Alternative exemplary embodiments are shown in FIGS. 2 and 3. Components, features, and functions that are essentially the same are labelled with the same reference numerals. To distinguish the exemplary embodiments from each other, the reference numerals of the exemplary embodiments are appended with the letters a, b, and c. The description below is essentially limited to the differences from the exemplary embodiment in FIG. 1. With regard for the components, features, and functions that remain the same, reference is made to the description of the exemplary embodiment in FIG. 1.

FIG. 2 shows a schematicized longitudinal section view of a hand-held power tool designed as a rotary hammer that includes a motor 10b, which is provided as an electric motor, and that includes a motor shaft 12b and an impact mechanism 14b, which is driveable by motor 10b via motor shaft 12b, for generating an impulse in the direction of an impact axis 16b. Impact mechanism 14b includes an axial drive unit 18b designed as an eccentric unit, with a driven element 20b designed as an eccentric peg. Axial drive unit 18b includes a gearwheel 58b that meshes with motor pinion 32b integrally formed with motor shaft 12b, and on which a shaft 60b is located, on a side facing motor 10b. Shaft 60b is connected with an eccentric disk of the eccentric unit on a side facing motor 10b. Driven element 20b formed by the eccentric peg is located directly on the side of eccentric disk of eccentric unit that faces motor 10b. As viewed in the longitudinal direction of shaft 60b, axial drive unit 18b is supported in front of and behind gearwheel 58b on the side of the eccentric disk facing away from motor 10b. Motor shaft 12b is supported on the side of motor pinion 32b facing away from motor 10b, although—in addition or as an alternative thereto—it could be supported on the side of motor pinion 32b facing motor 10b and on the side of transmission unit 22b facing away from motor 10b, as shown in FIG. 2. Motor 10b is separated from impact mechanism 14b via a partition 66b and a gasket 68b located in partition 66b, and is therefore protected from lubricant.

Motor pinion 32b also meshes directly with an intermediate wheel 30b of the hand-held power tool, which is provided for rotationally driving a tool fitting 72b, and which—as viewed in the longitudinal direction of motor shaft 12b—is located on a side of impact axis 16b facing away from motor 10b. Intermediate wheel 30b is located on the side of motor shaft 12b facing tool fitting 72b—as viewed in the longitudinal direction of impact axis 16b—with tool fitting 72b being located in an end region of a hammer tube 36b facing away from motor shaft 12b.

A bevel gear 62b is located on a side of intermediate wheel 30b facing hammer tube 36b, as viewed in the longitudinal direction of a rotation axis of intermediate wheel 30. Bevel gear 62b meshes with a crown wheel 64b located on hammer tube 36b. Crown wheel 64b is non-rotatably connected with hammer tube 36b, although it could also be connected therewith via a switching device. Tool fitting 72b is driveable via hammer tube 36b.

FIG. 3 shows an alternative hand-held power tool provided in the form of a rotary hammer, which essentially corresponds to the hand-held power tool shown in FIG. 2. With regard for the hand-held power tool shown in FIG. 3, reference may therefore also be made in particular to the description of the exemplary embodiment shown in FIG. 2.

The hand-held power tool includes an intermediate wheel 30c for rotationally driving a tool fitting 72c, intermediate wheel 30c being coupled directly with and meshing with a driven element 34c—which is provided as a gearwheel—of an axial drive unit 18c, which is provided as an eccentric unit. Driven element 34c of axial drive unit 18c is located on a side of a gearwheel 58c of axial drive unit 18c facing away from motor 10c, gearwheel 58c meshing directly with a motor pinion 32c integrally formed with a motor shaft 12c. Intermediate Wheel 30c is non-rotatably located on a shaft 70c. A bevel gear 62c is located on the end of shaft 70c facing hammer tube 36c. Bevel gear 62c meshes with a crown wheel 64c, which is integrally formed with hammer tube 36c.

### REFERENCE NUMERALS

| | |
|---|---|
| 10 | Motor |
| 12 | Motor shaft |
| 14 | Impact mechanism |
| 16 | Impact axis |
| 18 | Axial drive unit |
| 20 | Driven element |
| 22 | Transmission unit |
| 24 | Piston unit |
| 26 | Recess |
| 28 | Output region |
| 30 | Intermediate wheel |
| 32 | Motor pinion |
| 34 | Driven element |
| 36 | Hammer tube |
| 38 | Piston |
| 40 | Transmission element |
| 42 | Joint |
| 44 | Joint |
| 46 | Center |
| 48 | Center |
| 50 | Distance |
| 52 | Redirection |
| 54 | Redirection |
| 56 | Subregion |
| 58 | Gearwheel |
| 60 | Shaft |
| 62 | Bevel gear |
| 64 | Crown wheel |
| 66 | Partition |
| 68 | Gasket |
| 70 | Shaft |
| 72 | Tool fitting |
| 74 | Angle |

What is claimed is:

1. A hand-held power tool, in particular a rotary hammer and/or a chisel hammer, including a motor (10a, 10b, 10c) and a motor shaft (12a, 12b, 12c), with an impact mechanism (14a, 14b, 14c), which is driveable by a motor (10a, 10b, 10c) and generates an impulse in the direction of an impact axis (16a, 16b, 16c), and which includes an axial drive unit (18a, 18b, 18c) with a driven element (20a, 20b, 20c), and including a transmission unit (22a, 22b, 22c), which is provided to transfer a drive force from the axial drive unit (18a, 18b, 18c) to a piston unit (24a, 24b, 24c),
wherein
the motor shaft (12a, 12b, 12c)—as viewed in the longitudinal direction of the impact axis (16a, 16b, 16c), in the region of the transmission unit (22a, 22b, 22c)—is guided laterally past at least one portion of the transmission unit (22a, 22b, 22c).

2. The hand-held power tool as recited in claim 1,
wherein
the transmission unit (22a, 22b, 22c) includes a recess (26a, 26b, 26c), through which the motor shaft (12a, 12b, 12c) is guided.

3. The hand-held power tool as recited in claim 1
wherein
the axial drive unit (18a, 18b, 18c) is formed by an eccentric unit.

4. The hand-held power tool as recited in claim 3,
wherein
the eccentric unit—as viewed in the longitudinal direction of the motor shaft (12a, 12b, 12c)—is supported at least on a side facing away from the motor (10a, 10b, 10c).

5. The hand-held power tool as recited in claim 4,
wherein
the eccentric unit—as viewed in the longitudinal direction of the motor shaft (12a, 12b, 12c)—is supported at least partially on a side of a driven region (28a, 28b, 28c) of the motor shaft (12a, 12b, 12c) facing away from the motor (10a, 10b, 10c).

6. The hand-held power tool as recited at least in claim 3,
wherein
the eccentric unit is supported on one side.

7. The hand-held power tool as recited in claim 1, characterized by an intermediate wheel (30b, 30c) for rotationally driving a tool fitting (72a, 72b, 72c), which—as viewed in the longitudinal direction of the motor shaft (12b, 12c)—is located at least partially on a side of the impact axis (16b, 16c) facing away from the motor (10b, 10c).

8. The hand-held power tool as recited in claim 7,
wherein
the intermediate wheel (30b, 30c)—as viewed in the longitudinal direction of the impact axis (16b, 16c)—is located at least partially on the side of the motor shaft (12b, 12c) facing the tool fitting (72b, 72c).

9. The hand-held power tool as recited in claim 7, characterized by a motor pinion (32b), which is driveable directly by the motor shaft (12b) and is coupled directly with the intermediate wheel (30b).

10. The hand-held power tool as recited in claim 1, characterized by an intermediate wheel (30c) for rotationally driving a tool fitting and which is directly coupled with a driven element (34c) of the axial drive unit (18c).
